(19) United States
(12) Patent Application Publication
(10) Pub. No.: US 2004/0249042 A1
(43) Pub. Date: Dec. 9, 2004

(54) Microwave removable coating

(75) Inventors: Steven M. Scheifers, Hoffman Estates, IL (US); William F. Hoffman, Palatine, IL (US)

Correspondence Address: Frank C. Nicholas, CARDINAL LAW GROUP, Suite 2000, 1603 Orrington Avenue, Evanston, IL, 60201, US

(73) Assignee: MOTOROLA, INC.

(21) Appl. No.: 10/457,300

(22) Filed: Jun. 9, 2003

(51) Int. Cl. B05D 1/00; C08K 3/18; C08K 3/08; B65B 33/00

(52) U.S. Cl. 524/430; 427/154; 524/439

(57) ABSTRACT

A coating for assisting in the removal of components from devices comprising a polymer and a microwave absorbing substance dispersed in the polymer, so that when the coating is applied on a surface of a device and overlaid with a component and exposed to microwaves, the microwave absorbing substance absorbs the microwaves and allows for the component to be separated from the device.

### FIELD OF THE INVENTION

This invention relates generally to polymeric coatings. More specifically, it relates to microwave absorbing polymers and microwave absorbing additives to polymeric coatings used to attach and release a component to and from a recyclable device.

### BACKGROUND OF THE INVENTION

The proliferation of computer, peripheral and wireless devices such as pagers and cell phones has created a new form of waste referred to as e-waste. These devices may be painted or coated with materials to improve their appearance for marketability. In addition, articles may be affixed to these devices to identify them or add functionality to them. Several countries have regulations requiring that a percentage of the e-waste be reclaimed through recycling. Since the paint or affixed component may not be compatible with the recycling of the materials to which it is affixed, it must be removed before recycling. There is interest in finding simple methods to remove the paint and any other non-recyclable material from such devices.

Prior art includes the use of solvents, which are not environmentally friendly. Sometimes solvents are used to swell the material and then the paint is peeled off. Blasting is a method to remove paint, but blasting cannot easily get paint out or corners and hinges. U.S. Pat. No. 6,051,168 describes an apparatus with rollers rotating at different speeds and passing a painted device through a gap between the rollers to stress and peel the paint.

It is desirable to find a simple and quick technique to remove paint from pagers, cell phone and other such devices to allow for recycling of the devices. It is additionally desired to find a simple and quick technique to open plastic devices for repair, replacement or removal of the internal components of the devices.

### SUMMARY OF THE INVENTION

One aspect of the present invention provides a coating for assisting in the removal of components from devices comprising a polymer. The coating further comprises a microwave absorbing substance dispersed in the polymer. The coating is applied to a surface of a device. A component is overlaid on the coating applied to the surface so that when the coating is exposed to microwaves, the microwave absorbing substance absorbs the microwaves and allows for the component to be separated from the device.

Another aspect of the present invention provides a method of treating a device for the removal of components by dispersing a microwave absorbing substance in a polymer to form a coating material and applying the coating material to a device.

A third aspect of the present invention provides a method of removing a component from a device by providing a device having a microwave absorbing coating, which underlies a component, applied on a surface of a device, then emitting microwaves and absorbing the emitted microwaves in the microwave absorbing coating.

A fourth aspect of the present invention provides a method of treating a device for separation into structural components of the device by dispersing a microwave absorbing substance in a polymer to form a coating material, applying the coating material to contacting interface surfaces of a structural component of a device and adhering the structural components to each other to form the device. A fifth aspect of the present invention provides a method of separating a device into structural components by providing a device having a microwave absorbing coating adhering the structural components of a device together, then emitting microwaves and absorbing the emitted microwaves in the microwave absorbing coating.

The forgoing device and method and other devices and methods as well as features and advantages of the present invention will become further apparent from the following detailed description of the presently preferred embodiments, read in conjunction with the accompanying drawings. The detailed description and drawings are merely illustrative of the present invention rather than limiting, the scope of the present invention being defined by the appended claims and equivalents thereof.

### BRIEF DESCRIPTION OF THE DRAWINGS

The present invention is illustrated by way of example and not limitation in the accompanying figures, in which like references indicate similar elements, and in which:

FIG. 1 illustrates a schematic in cross-section of a first embodiment of a device with a microwave removable coating.

FIG. 2 illustrates a schematic in cross-section of a second embodiment of a device having a microwave removable coating.

FIG. 3 illustrates a schematic of a microscopic view of the microwave removable coating.

FIG. 4 illustrates a schematic of functional groups grafted to a polymer backbone.

FIG. 5 illustrates the frequency spectrum of the dielectric constant and dielectric loss for water.

FIG. 6 illustrates schematically in cross-section, the first embodiment of FIG. 1 upon initial exposure to microwaves.

FIG. 7 illustrates schematically in cross-section, the first embodiment of FIG. 6 upon additional exposure to microwaves.

FIG. 8 illustrates a schematic in cross-section of the first embodiment of FIG. 7 and a third embodiment of FIG. 9 after exposure to microwaves.

FIG. 9 illustrates schematically in cross-section, a third embodiment of a device during exposure to microwaves.

FIG. 10 illustrates schematically in cross-section, structural components of a device.

FIG. 11 illustrates schematically in cross-section adhered structural components of a device.

### DETAILED DESCRIPTION OF THE PRESENTLY PREFERRED EMBODIMENT

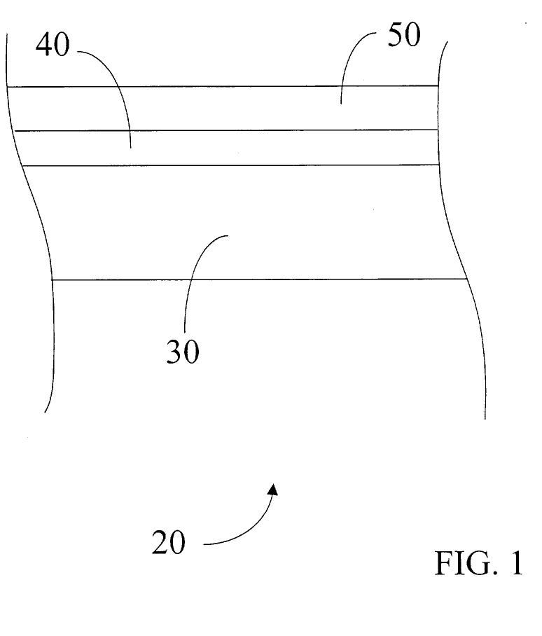

FIG. 1 illustrates device 20, a first embodiment of this invention, which comprises a recyclable device 30 coated with a microwave absorbing coating 40. The microwave absorbing coating 40 is coated by a paint layer 50. It is desirable to remove the paint layer 50 from the recyclable device 30, prior to recycling of the recyclable device 30 for its constituent material, for example, plastic.

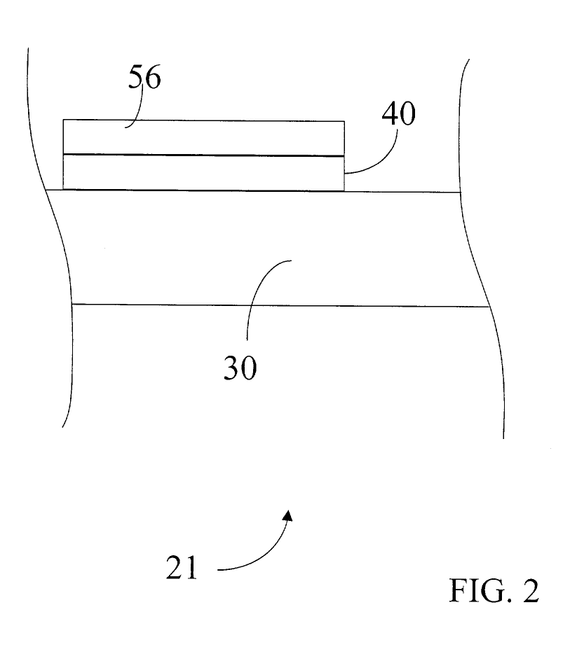

FIG. 2 illustrates device 21, a second embodiment of this invention, which comprises a recyclable device 30 partially covered with a microwave absorbing coating 40. A component 56 overlies the microwave absorbing coating 40. Component 56 can be a label or a soft polymer such as, for example, a foam rubber piece. In an example, it is desirable to remove the label or soft polymer from the recyclable device 30 prior to recycling device 30 for its constituent material such as, for example, plastic. A plurality of components 56 can be attached by a microwave absorbing coating 40 to the recyclable device 30.

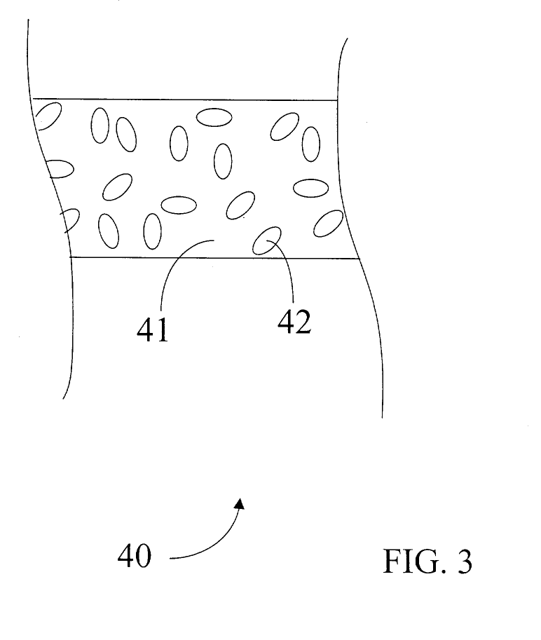

FIG. 3 is a schematic of a microscopic view of one embodiment of the microwave absorbing coating 40. The layer is comprised of a polymer 41, including, but not limited to, polymethylmethacralate (PMMA), polysiloxane, poly(vinyl alcohol) (PVA), polyvinyl chloride (PVC), polycarbonate (PC), acrylonitrile butadiene styrene (ABS), PC/ABS, nylon, polyphenylene oxide (PPO), and high impact polystyrene (HIPS) with a microwave absorbing substance 42 dispersed throughout the polymer 41. The microwave absorbing substance 42 is illustrated, in FIG. 3, as particles suspended in the polymer 41. The microwave absorbing substance 42 can be fine particles of metal, alumina, titanates, ceramics, or any other material that absorbs microwave frequencies from 1 GHz to 10 GHz, the preferred, though not exclusive, range of microwave frequencies. An alternate embodiment, not illustrated, is formed by dissolving a microwave absorbing polymer (not shown) into the polymer 41. The microwave absorbing polymers include any conductive polymers including both intrinsically and extrinsically conducting polymers. A partial list includes polyphenylene, polyacetylene, polythiophene, poly(ethylene dioxythiophene), poly (3,4-diphenylpyrrole), poly(3-octylthiophene), polyaniline, poly(vinylidene fluoride), and polypyrroles.

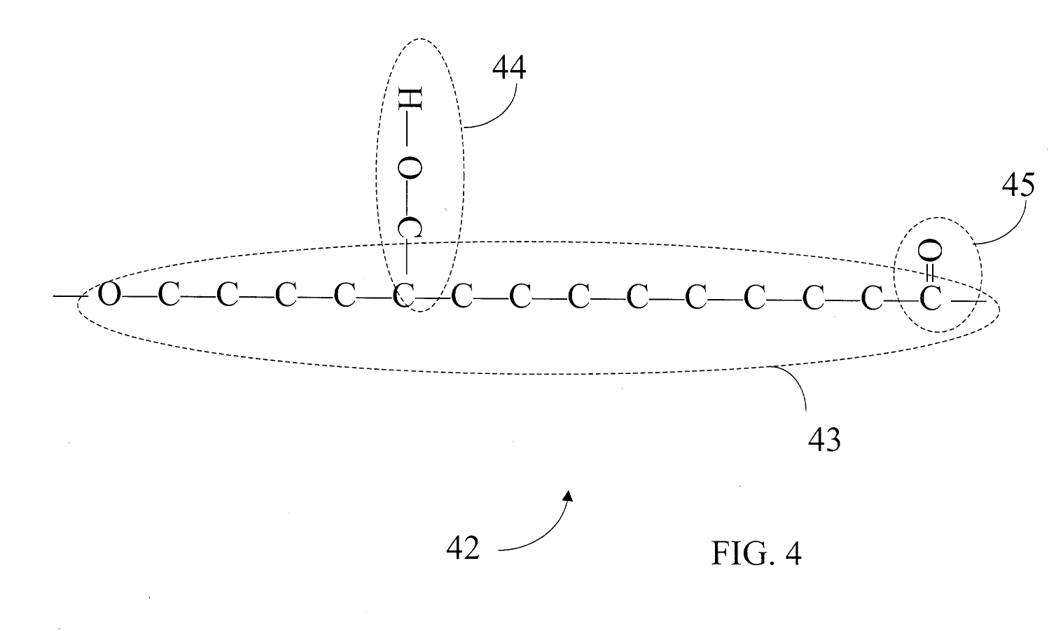

FIG. 4 illustrates an alternate embodiment of the microwave absorbing substance 42. Microwave absorbing functional groups 44 can be grafted onto a polymer backbone 43. Alternatively, an additional microwave absorbing functional group or groups 45 can be incorporated into the polymer backbone. Polymer backbones 43 are, in an example, chains of carbon or silicon. Functional group 44 is a hydroxyl group and the additional functional group 45 is a carbonyl group. In a currently preferred embodiment, hydroxyls are a preferred functional group 44 as they have the correct polarizability to absorb at the preferred microwave frequency of 10 GHz.

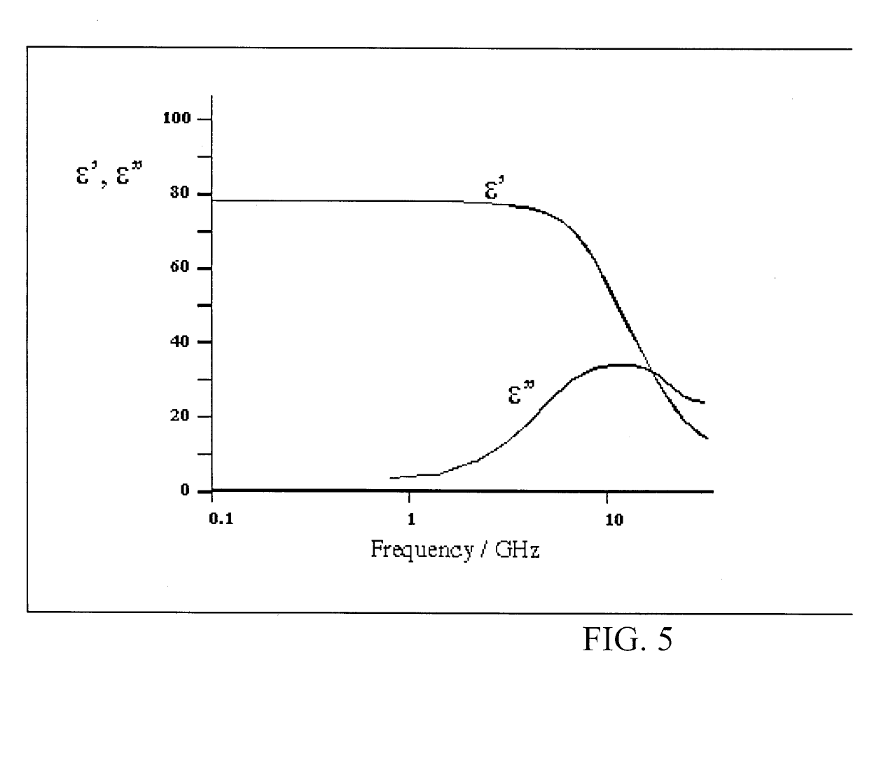

FIG. 5 is a frequency spectrum of the dielectric constant, ε′, and dielectric loss, ε″, for water. The dielectric loss ε″ of a material correlates to the absorption spectrum of a material. Hydroxyl groups have an absorption spectrum similar to that of water in the microwave region. If the microwave absorbing substance 42 is a hydroxyl group, then the microwave absorbing coating 40 itself will absorb most strongly at 10 GHz.

Other functional groups, which can be grafted onto the polymer backbone 43 and which absorb microwave radiation, include halogens, mercaptyls, sulphates, phosphates, carboxylic acids, esters, amines, amides, and nitro groups. In an example, only one type of functional group, such as, for example, either 44 or 45 in FIG. 4, is incorporated on the polymer backbone.

Device 20 is formed by dispersing a microwave absorbing substance 42 in a polymer 41 and applying it as layer 40 (FIG. 1) to the recyclable device 30. Then a paint layer 50 or at least one component 56 (FIG. 2) is attached to the recyclable device 30 by the adhesive properties of the microwave absorbing coating 40. The paint layer 50 can be formed from the microwave absorbing coating 40 by adding pigment and other additives as well as a microwave absorbing substance 42 to the polymer 41. We are describing a paint layer to illustrate the present invention, but the paint layer can be any other functional layer including a decorative enamel layer, an anti-corrosion layer and a scratch resistant coating layer. Alternately, the paint layer 50 can include decorative material, such as sparkles, tinsel or decals.

There are several ways in which the microwave absorbing substance 42 (FIG. 3) can cause a release of the paint layer 50 adhered to a recyclable device 30.

One method occurs when absorption of microwave energy by the microwave absorbing substance 42 (FIG. 3) causes a differential heating between the microwave absorbing coating 40 and the paint layer 50. Loss of adhesion occurs as the differential heating causes differential expansion of the microwave absorbing coating 40 relative to the paint layer 50.

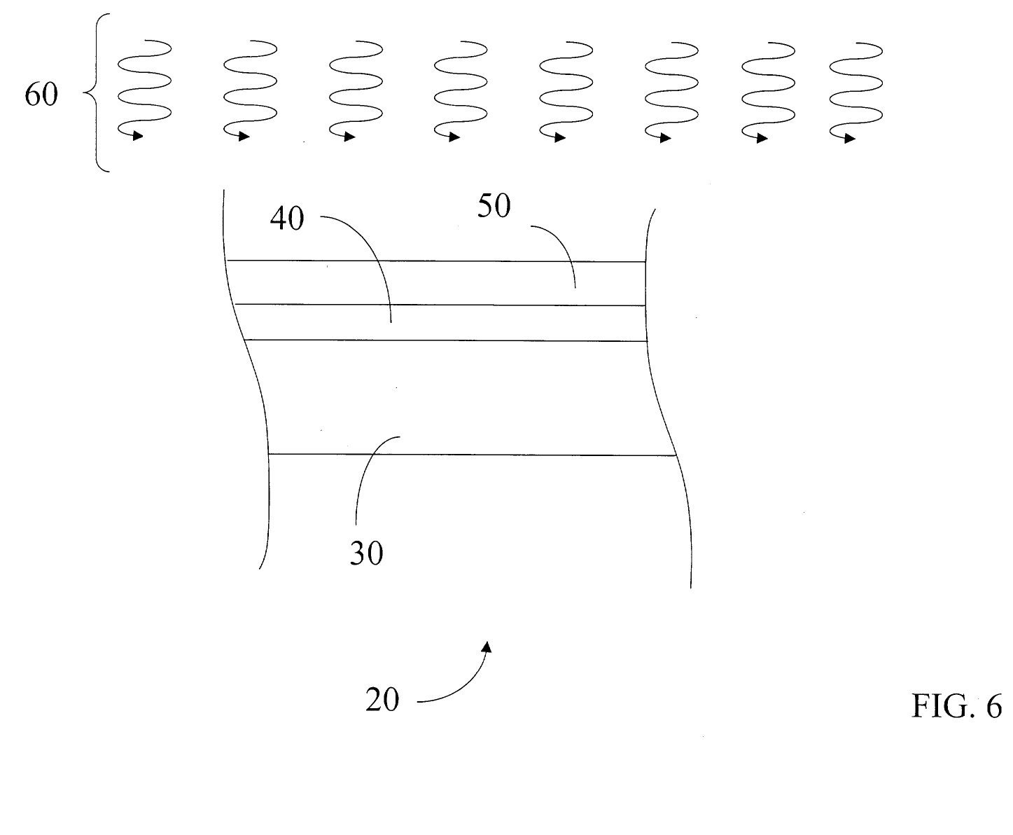

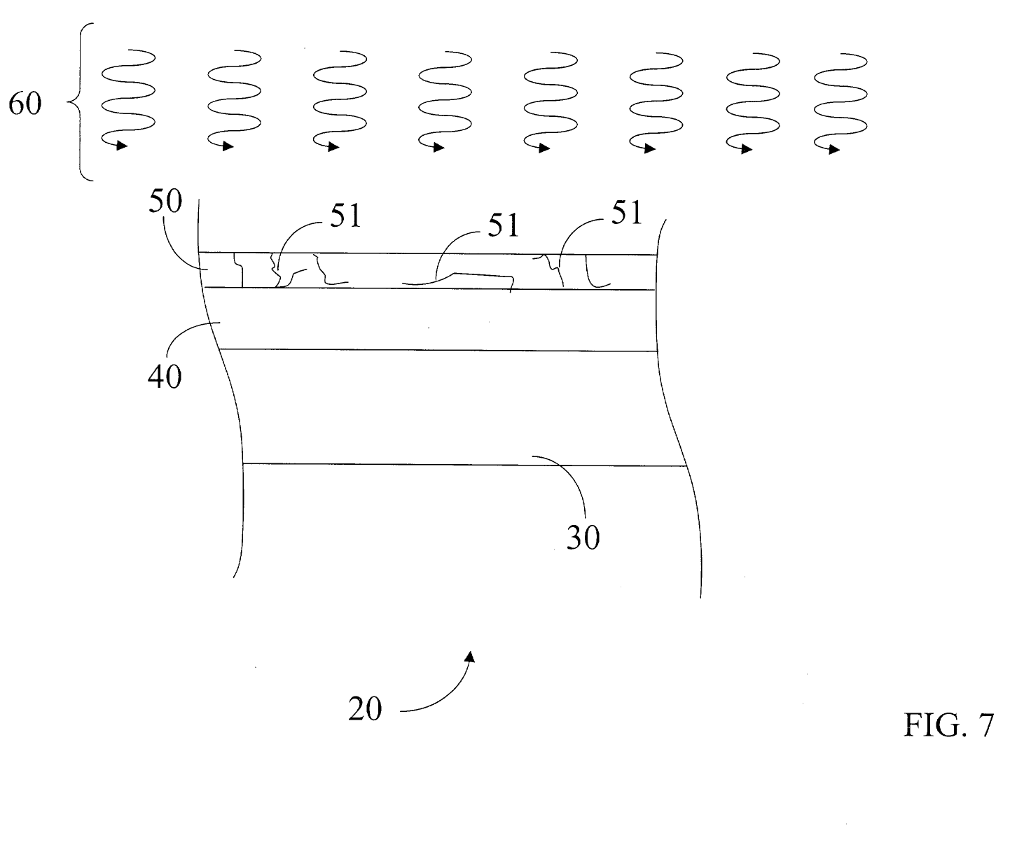

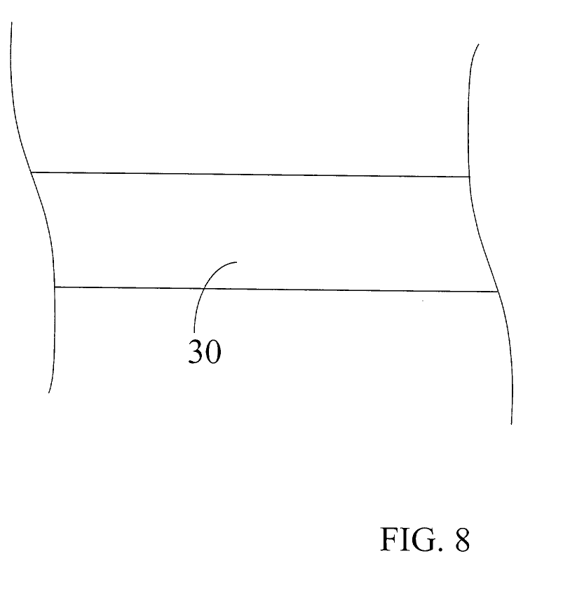

This effect is illustrated in FIGS. 6-8. FIG. 6 illustrates a device 20 as it is initially exposed to microwaves 60 emitted from a source (not shown). The frequency of the microwaves 60 impinging on device 20 is chosen to be within the absorption range of the microwave absorbing substance 42 (FIG. 3) contained in the microwave absorbing coating 40 or within the absorption range of the microwave absorbing coating 40 when the microwave absorbing substance 42 (FIG. 3) is absent. FIG. 7 illustrates the device 20 of FIG. 6 at a later time, after the microwave absorbing coating 40 has absorbed the microwaves 60 and increased in size relative to the paint layer 50. The unexpanded or lesser expanded paint layer 50, reacting to the expanded microwave absorbing coating 40, has cracks 51 in multiple places. When the paint layer 50 has enough cracks 51 to be loosened from microwave absorbing coating 40, device 20 can be removed from the field of the microwaves 60. It is preferred that the microwave absorbing coating 40 be removed from the device 30 along with the paint layer 50. In an example, the described expansion of the microwave absorbing coating 40, which reduced the adhesion of the paint layer 50, also reduces the adhesion of microwave absorbing coating 40 to the recyclable device 30, leaving just the recyclable device 30, as illustrated in FIG. 8. The substantially complete removal of paint layer 50 and microwave absorbing layer 40 can be accomplished by a follow up cleaning which can include blasting with air, brushing, shaking or vibrating device 20 using, for example, an ultrasonic belt or plate. In like manner, this use of differential heating can be used to remove component 56 (FIG. 2) attached to the recyclable device 30 by microwave absorbing coating 40.

In an alternate method for removal of the paint layer 50, the microwave absorbing coating 40 is designed with a first coefficient of thermal expansion that differs from a second coefficient of thermal expansion of the adhered paint layer 50. Upon substantially uniform heating of the microwave absorbing coating 40 and the adhered paint layer 50, there is a differential expansion of the microwave absorbing coating 40 with respect to the adhered paint layer 50, which results in a loss of adhesion. This process is also illustrated in FIGS. 6-8, for the case when the microwave absorbing coating 40 has a higher coefficient of thermal expansion than the adhered paint layer 50. Additionally, this use of differential coefficients of thermal expansion can be used to remove component 56 attached to the recyclable device 30 by microwave absorbing coating 40. For some material systems, the effects of both differential heating and differential thermal expansion coefficients may occur simultaneously.

Cohesive and adhesive failure are also induced by heat related degradation or chemically induced degradation of the microwave absorbing coating 40, either of which is instigated by the absorption of microwave energy 60 by the microwave absorbing substance 42 or by the microwave absorbing coating 40 itself.

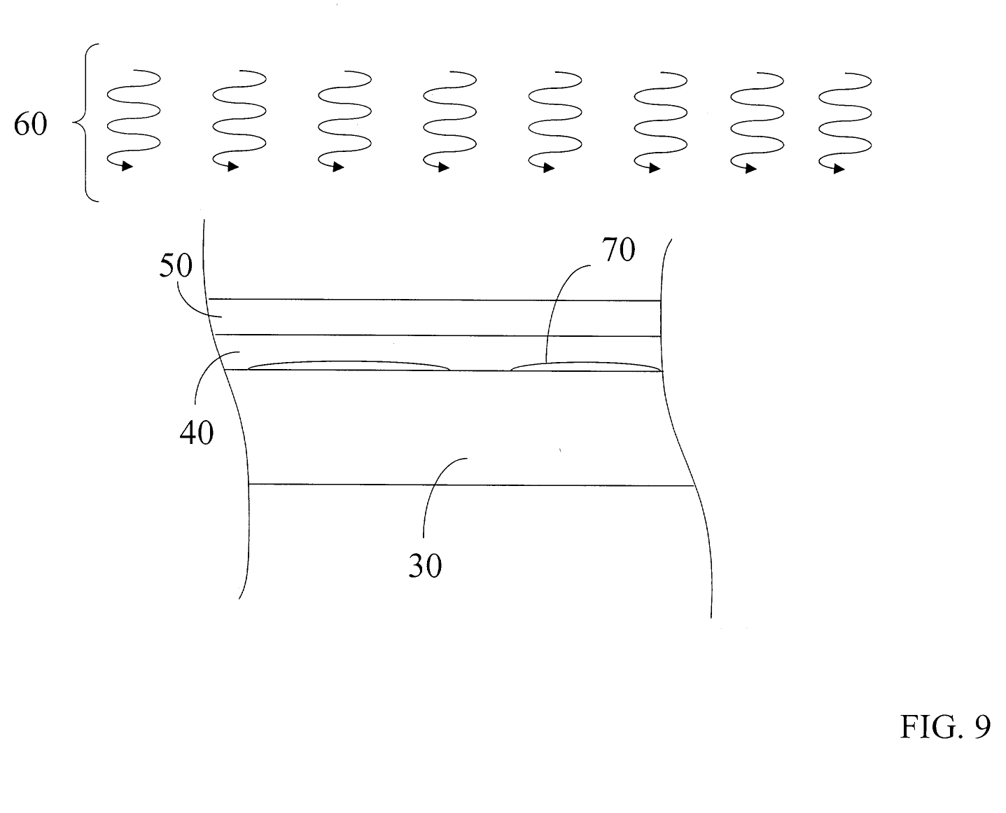

An adhesive failure mechanism occurs when the microwave absorbing substances 42 are conductive materials such as metal flakes, conductive polymers or when the microwave absorbing coating 40 and microwave absorbing substance 42 are the same, e.g. an iodine doped polyacetylene or a poly(vinylidene fluoride). In that case the microwave absorbing coating 40 loses its adhesive property and delaminates from recyclable device 30. Delaminating gaps 70 form between microwave absorbing coating 40 and recyclable device 30 when device 20 is exposed to microwaves 60, as illustrated in FIG. 9. These gaps 70 cause the paint layer 50 and microwave absorbing coating 40 to fall off recyclable device 30. A final removal of paint layer 50 and microwave absorbing coating 40 can be accomplished by blasting with air, brushing, shaking or vibrating device 30 using, for example, an ultrasonic belt or plate. Then only recyclable device 30 remains, as illustrated in FIG. 8. In like manner, this loss of adhesive properties of microwave absorbing coating 40 can be used to remove component 56 attached to the recyclable device 30 by microwave absorbing coating 40.

In certain embodiments, microwave absorbing substances 42, such as, for example, metal flakes and conductive polymers are combined with other reactive additives (e.g. adipic acid) or pendant groups grafted into one of the matrix materials (e.g. a free carboxylic acid group) that promote degradation. A microwave absorbing coating 40 comprised of such a material combination will lose its cohesive property upon exposure to microwaves 60. In addition, loss of viscosity can be a mechanism for cohesive failure, e.g. with lower melting polymer matrices and with adhesives that lose viscosity when heated. In these cases, the microwave absorbing coating 40 will lose cohesive integrity, causing gaps within the microwave absorbing coating 40 and between the microwave absorbing coating 40 and the recyclable device 30 as illustrated in FIG. 9. Then the microwave absorbing coating 40 and the overlying paint layer 50 will fall off the recyclable device 30 when it is exposed to microwaves 60. It may be desirable to perform an in situ or a follow up cleaning of device 30 by blasting device 30 with air, or by brushing, shaking or vibrating of the device 30. In like manner, this loss of cohesive properties of microwave absorbing coating 40 can be used to remove component 56 attached to the recyclable device 30 by microwave absorbing coating 40.

In a currently preferred embodiment, the frequency of the microwaves 60 is equal to the peak absorption frequency of the microwave absorbing substance 42 (FIG. 3) and the microwave absorbing coating 40 in FIG. 1 in order to reduce the exposure time and/or the power levels of the microwaves 60 needed to loosen the paint layer 50.

Some or all of these effects may occur simultaneously resulting in the microwave absorbing coating 40 to under go thermal expansion, while losing adhesive and/or cohesive properties.

In like manner, device 21 with component 56 attached to the recyclable device 30 by microwave absorbing coating 40, as illustrated in FIG. 2, can be exposed to microwaves to remove component 56. If the components 56 are not recyclable, it is desirable to remove components 56 from recyclable devices prior to recycling. For example, a cell phone contains snubbers or foam rubber pieces, which act as shock absorbers for the cell phone. Snubbers are not recyclable with the plastic housing and must be removed prior to recycling of the plastic housing. Labels are on devices and must be removed prior to recycling. The microwave absorbing coating 40 can be used to attach the label to the recyclable device 30. If a paint layer 50 and a component 56 are on a device then one or more layers of microwave absorbing coating 40 can be used.

This is also a simple technique to remove paint and other materials from a device. If pigment and other additives are added to the microwave absorbing material, an additional manufacturing step is not required. An assembly line to remove the paint can be used, conveying the decorated or painted devices 20 through a microwave field and then through an air knife or onto a vibrating belt, or such equipment to separate the paint layer 50 and other removed components 56 from the recyclable device 30.

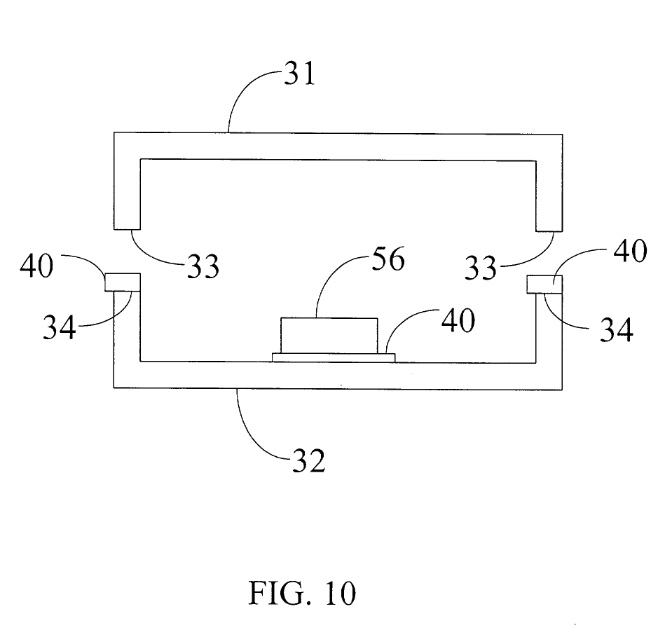

FIG. 10. illustrates the use of the microwave absorbing coating 40 as a glue to adhere parts together. FIG. 10 shows device 30 comprising a first structural component 31 and a second structural component 32. A component 56 is attached with microwave absorbing coating 40 to the second structural component 32 to provide a function for the device 30. In this illustration, edges 33 and 34 form the contacting interface surfaces for structural components 31 and 32, respectively. The microwave absorbing coating 40 is placed on the edge 34 of the second structural component. The microwave absorbing coating 40 could also have been put on the edge 33 of the first structural component in addition to the microwave absorbing coating 40 on edge 34, or in place of the microwave absorbing coating 40 on edge 34.

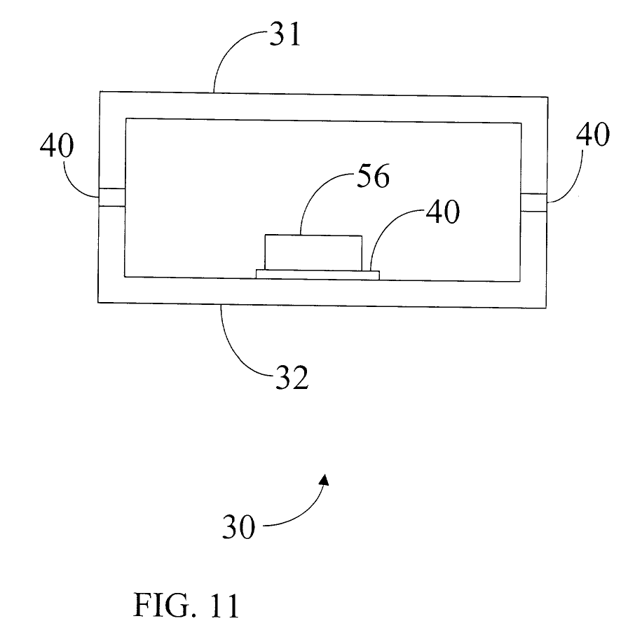

FIG. 11 illustrates the first structural component 31 and the second structural component 32 in contact along their respective edge 33 and edge 34. The microwave absorbing coating 40 is a microwave removable glue and will hold the first structural component 31 and the second structural component 32 together to form device 30. This device may be painted as described above, if desired. If it is later desired to replace component 56 with a more advanced functioning component 56, the device 30 can be exposed to microwaves 60, as in FIG. 6 and FIG. 9, to separate the first structural component 31 from the second structural component 32 as described above.

At the same time or separately, if so designed, device 56 will be separated from the second structural component 32 for easy removal. This selectivity can be obtained by using microwave absorbing coatings 40, which absorb different microwave frequencies, to attach the components 56 and to adhere the first structural component 31 to the second structural component 32. If the frequency of the microwaves are not absorbed by the microwave absorbing coating 40 which attaches the component 56 to the first structural component 31, but it is absorbed by the microwave absorbing coating 40, which fixed the first structural component 31 to the second structural component 32, then the first structural component 31 and the second structural component 32 will separate and the component 56 will still be attached to the first structural component 31. This technique can be used to repair or replace components 56 or to remove components 56 internal to the device 30 prior to recycling device 30.

From the above description, it is clear that the microwave absorbing coating 40 functions as an adhesive as well as a microwave absorbing medium. This is a simple technique to separate parts from each other. This separation of parts is desirable when plastic devices such as televisions, compact disc players and the like need to be opened for repair, replacement or re-use of any of the internal components 56 of the device 30.

The illustrated schematics of devices 20, 21 (FIG. 1 and FIG. 2) are meant to illustrate a way to attach non-recyclable materials 50, 56 to a recyclable device 30 in order to later easily remove the non-recyclable materials 50, 56 from recyclable device 30, prior to recycling the recyclable device 30. By placing the devices 20, 21 in an emitted microwave field (FIG. 6 and FIG. 9) the non-recyclable or incompatible materials 50, 56 are released from the recyclable device 30. The illustrative schematics of first and second structural component 31-32 and device 30 (FIG. 10-11) are meant to illustrate a way to attach structural components 31-32 and components 56 in order to easily separate a device 30 into the structural components 31-32, which comprise the device 30. These illustrative schematics are not intended to be exhaustive of all possibilities or to limit what can be designed for the aforementioned purpose. By using what is shown and described herein, removal of non-recyclable materials from recyclable device is simplified.

We claim

1. A coating for assisting in the removal of components from devices comprising:
a polymer; and
a microwave absorbing substance dispersed in the polymer, wherein when the coating is applied on a surface of a device and overlaid with a component and exposed to microwaves, the microwave absorbing substance absorbs the microwaves and allows the component to be separated from the device.

2. The coating of claim 1, wherein the microwave absorbing substance dispersed in the polymer is comprised of a microwave absorbing polymer.

3. The coating of claim 1, wherein the component to be removed is selected from the group consisting of a paint layer, a decorative enamel layer, an anti-corrosion layer and a scratch resistant coating layer.

4. The coating of claim 1, wherein the component to be removed is a soft polymer.

5. The coating of claim 1, wherein the component to be removed comprises the structural sections which form a device structure.

6. The coating of claim 1, wherein the microwave absorbing substance is dispersed in the polymer by grafting microwave absorbing functional groups to the backbone of the polymer.

7. The coating of claim 6, wherein the microwave absorbing functional groups cause an adhesive property of the coating to decrease when the coating is exposed to microwaves.

8. The coating of claim 6, wherein the microwave absorbing functional groups cause a cohesive property of the coating to decrease when the coating is exposed to microwaves.

9. The coating of claim 6, wherein the microwave absorbing functional groups cause the coating to increase in temperature when the coating is exposed to microwaves.

10. The coating of claim 6, wherein microwave absorbing functional groups are selected from the group consisting of halogens, hydroxyls, mercaptyls, sulphates, phosphates, carboxylic acids, esters, amines, amides, and nitro groups.

11. The coating of claim 1, wherein the microwave absorbing substance is dispersed in the polymer by mixing microwave absorbing particles into the polymer.

12. The coating of claim 11, wherein the microwave absorbing particles are selected from the group consisting of metal, alumina, titanates, conductive polymers and ceramics.

13. The coating of claim 11, wherein the microwave absorbing particles cause the coating to increase in temperature when the coating is exposed to microwaves.

14. The coating of claim 11, wherein the microwave absorbing particles cause an adhesive property of the coating to decrease when the coating is exposed to microwaves.

15. The coating of claim 11, wherein the microwave absorbing particles cause a cohesive property of the coating to decrease when the coating is exposed to microwaves.

16. The coating of claim 11, wherein the microwave absorbing particles are maintained in suspension in the polymer.

17. The coating of claim 11, wherein the microwave absorbing particles are dissolved in the polymer.

18. The coating of claim 1, further comprising:
a pigment and other additives dispersed in the polymer, wherein the coating acts as a paint layer.

19. A method of treating a device for removal of components, the method comprising:
dispersing a microwave absorbing substance in a polymer to form a coating material; and
applying the coating material to a device.

20. The method of claim 19, further comprising:
adhering at least one component on the coated device.

21. The method of claim 19, further comprising: dispersing a pigment and other additives in the coating material, wherein the coating material acts as a paint layer.

22. The method of claim 21, further comprising: adhering at least one component on the coating material acting as a paint layer.

23. The method of claim 19, wherein the components to be removed are selected from the group consisting of a paint layer, a decorative enamel layer, an anti-corrosion layer and a scratch resistant coating layer.

24. The method of claim 19, further comprising:
applying a paint layer over the coating material; and
adhering at least one component on the paint layer.

25. A method of removing a component from a device, the method comprising:
providing a device having a microwave absorbing coating, which underlies a component, applied on a surface of a device;
emitting microwaves; and
absorbing the emitted microwaves in the microwave absorbing coating.

26. The method of claim 25, further comprising:
expanding the microwave absorbing coating in response to the absorbing of the emitted microwaves; and
releasing the component from the device in response to the expanding of the microwave absorbing coating.

27. The method of claim 25, further comprising:
reducing an adhesive property of the microwave absorbing coating in response to the absorbing of the emitted microwaves; and
removing the component overlying the non-adhesive layer from the device.

28. The method of claim 25, further comprising:
reducing a cohesive property of the microwave absorbing coating in response to the absorbing of the emitted microwaves; and
removing the component overlying the non-cohesive layer from the device.

29. A method of treating a device for separation into structural components of the device, the method comprising:
dispersing a microwave absorbing substance in a polymer to form a coating material;
applying the coating material to contacting interface surfaces of a structural component of a device; and
adhering the structural components to each other to form the device.

30. A method of separating a device into structural components, the method comprising:
providing a device in which a microwave absorbing coating adheres the structural components of the device together;
emitting microwaves; and
absorbing the emitted microwaves in the microwave absorbing coating.
